(19) United States
(12) Patent Application Publication
(10) Pub. No.: US 2004/0069336 A1
(43) Pub. Date: Apr. 15, 2004

(54) Modified crutch with three mode lower leg/foot support

(76) Inventor: Tessanie Marie Marek, Salado, TX (US)

Correspondence Address: DAVID G. HENRY, 7th Floor, 900 Washington Avenue, P.O. Box 1470, Waco, TX, 77603-1470, US

(21) Appl. No.: 10/271,339

(22) Filed: Oct. 15, 2002

(51) Int. Cl. A61H 3/02

(52) U.S. Cl. 135/68

(57) ABSTRACT

The present invention relates to an ordinary crutch modified with a straight support which may be formed from a solid, lightweight tubular member, said support connected at one end to near the bottom portion of the crutch and with a bicycle pedal-like cushion on the other end for which the calf, shin or cast of the injured leg or leg of the injured foot rests. Since the pedal can freely revolve from its attachment to the solid support member, the angle at which the leg rests on the pedal relative to the crutch may be readily optimized for the patient's comfort in order to relieve pain and discomfort. Also, fatigue from the body when supporting the dangling leg may be avoided as the leg no longer dangles with its concomitant “dead weight”, because the entire weight of the leg is resting on the cushion of the leg support, the knee is flexed or extended while standing, or while sifting. Such an apparatus is easily assembled, does not add any substantial weight to the crutch, and the modification is inexpensive to achieve.

### BACKGROUND OF THE INVENTION

1. Field of the Invention

Applicant's invention relates to a medical apparatus whereby a standard crutch is modified so as to allow the resting of a lower extremity while standing or sitting and thereby reducing discomfort, pain and further injury while facilitating recovery and mobility.

2. Background Information

Crutches are very widely used to assist ambulation in people with various disabilities and of all ages. Depending on the severity of the disability or injury, one may require the use of crutches from a few days to a few weeks or months to an indefinite period of time. Common reasons for the short-term or long-term use of crutches include fracture or sprain of a leg, foot, knee or ankle, post-surgery, arthritis, partial paralysis, accident, sports or occupational injury, etc. And in today's mobile and demanding society, daily and prolonged use of crutches or the need to travel distances with crutches is often times unavoidable.

When using a pair of conventional crutches for support and limited mobility, many people complain of adverse side effects, like underarm soreness, a numbing sensation in the lower arms, back and shoulder fatigue or pain, lower backache, etc. For example, fatigue may be caused by the constant and unintended use of the arms with the aid of the crutches to compensate for the lower body's inability to support the body weight or the unsupported, injured leg. To relieve arm fatigue, one might then chronically lean on the axillary or underarm rests when not walking or moving about in order to support the weight of the injured leg while the injured leg is off the ground. In turn, this will lead to temporary paralysis of the radial nerve, as manifested by underarm soreness and a numbing sensation in the arms. Another consequence of these problems is that they may force the user to use the injured or impaired leg more than necessary, and thus exacerbating the underlying problem.

Nevertheless, keeping weight off the injured extremity is essential to safe crutch walking, promoting effective healing and in avoiding permanent tissue and bone damage. It may also provide some pain relief. At any rate, it often helps to slightly bend the knee. But when one is using crutches, standing for an extended period of time may be unavoidable, which may lead to fatigue, pain, or worse because the body (e.g., the lower back or shoulders) has to constantly compensate for and support the “dead weight” of the impaired and dangling leg. Furthermore, places to sit down are just not always available or convenient. When there are places to sit then there is the problem of how to properly rest the leg with the injury, as resting the injured leg may result in an uncomfortable and painful pressure point from continuous contact with the floor or ground.

In summary, problems and shortcomings associated with the use of standard crutches on their own are sometimes unavoidable. These shortcomings and problems challenge both the short-term and long-term health and safety of the individual and progress or recovery time.

The present invention can reduce the unintended adverse effects of the use of standard crutches, e.g., pain and fatigue, facilitate the healing process and increase the comfort of the user by physically resting the injured leg (with the knee bent or flexed) on the leg support portion of the modified crutch and therefore not requiring the rest of the body, e.g., shoulder, hips and lower back, to compensate for the “dead weight” of the resting unsupported and dangling lower extremity. Such benefits from use of the current invention can be achieved while sitting or standing.

### SUMMARY OF THE INVENTION

The problems outlined above are addressed by the present invention, which comprises a simple and novel modification to the crutch to be used on the side of the injury and the other crutch being unmodified. The calf, shin or cast of the injured leg or the leg with the injured foot can be directly placed on the leg support portion of the modified crutch, and thereby reduce patient discomfort, redistribute the extra weight from the shoulders, lower back or hips when an injured leg or foot is freely suspended onto the leg support means, and facilitate the healing process. These benefits can be achieved when the leg support bar of the modified crutch is pointing forward and allowing the calf or cast of the injured leg or foot via an extended knee to rest on the bicycle pedal-like cushion at the end of the support. The same resting benefit can be achieved when the patient is sitting, as the calf or cast can rest on the cushion and relieve the foot of a painful pressure point due to contact with the floor or ground and relieve any other part of the body from holding up the injured leg or foot. Likewise the same benefit can be achieved when the leg support portion of the modified crutch is facing backward and thus allowing the shin or cast of the injured leg or leg of the injured foot to rest on the cushion when the knee is partially bent. In any of the preceding situations, such weight redistribution and support can eliminate or reduce the fatiguing and painful act of supporting a freely-suspended leg or the uncomfortable pressure points associated with supporting a leg on a rigid object, such as a piece of furniture.

It is an object of the present invention to provide a modified and improved crutch which includes a padded leg support means for dynamic support of the user's injured leg, instead of otherwise relying on the lower back, shoulders or hips of the user to support the dangling leg.

It is another object of the present invention to provide additional balance to the standing crutch user by allowing the body to stabilize itself without shifting weight to support the otherwise unsupported leg.

It is another object of the present invention to prevent fatigue to the standing crutch user by resting the leg with the injury on the padded leg support.

It is an object of the present invention to provide a modified and improved crutch for increased comfort level to the user while standing or sitting.

It is an object of the present invention to provide a modified and improved crutch for relief of pain associated with the body supporting the freely-suspended leg of the user while standing or sitting.

It is yet another object of the present invention to provide a limitless number of angles that the resting leg can have relative to the crutch while standing or sitting.

The advantages of the present invention will be further appreciated from the drawings and from the detailed description provided below.

### BRIEF DESCRIPTION OF THE DRAWINGS

FIG. 1 is a front view of a pair of crutches inserted into a crutch sling assembly in accordance with this invention.

FIG. 2 is a perspective view of the modified crutch being used as an elevated support for a patient's leg when standing with knees extended.

FIG. 3 is a perspective view of the modified crutch being used as an elevated support for a patient's leg when standing with knees partially bent.

FIG. 4 is a perspective view of the modified crutch being used as an elevated support for a patient's leg when sitting with knees extended.

### DETAILED DESCRIPTION OF THE PREFERRED EMBODIMENT

The current invention may be used immediately by any one with an injury to the right lower extremity or the left lower extremity, with or without a cast, without the necessity of dismounting and remounting any portion of the apparatus to accommodate a left leg or a right leg impairment. Depending upon the needs and desires of the user, the leg support provided by the current invention may be used while the user is standing still or sitting. It is contemplated that the user will use a conventional (non-modified) crutch for the non-injured side.

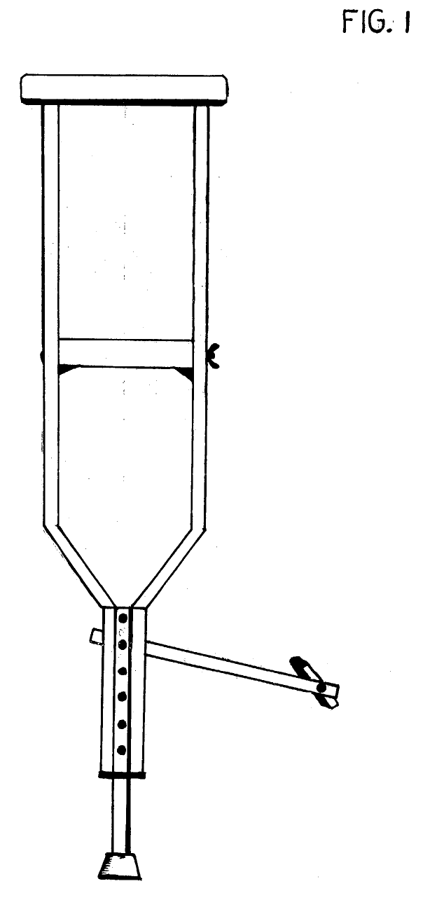

Referring now to the drawings, wherein like reference numerals designate identical or corresponding parts throughout the several views, and more particularly to FIG. 1 thereof, there is shown a crutch including a solid, straight, lightweight bar 12 and a freely-revolving bicycle pedal-like cushion 14.

In FIG. 1 the bar 12 may be made of a material that is known per se and is preferably made of aluminum because of its light weight and sturdiness. One end of the bar 12 is rigidly fixed or attached to lower portion of a crutch 10. Since the size of each pair of crutches should be fitted for the individual user, in the preferred embodiment one end of the bar 12 is rigidly affixed to the crutch 10 to be used on the side of the injury at a point approximately 32% up from the bottom of the crutch 10. In the preferred embodiment, the angle at which the bar 12 intersects with the crutch 10 is approximately 60 degrees. The core of the freely-revolving pedal cushion 14 is rigidly fixed to the other end of the bar 12. In the preferred embodiment the length of the bar 12 is approximately fourteen inches. The cushion 14 may be made of a material that is known per se and is preferably made of a reinforced, padded and woven fabric.

Whether the bar 12 and cushion 14 leg support assembly is pointed in a forward or backward direction and because the leg support means does not add substantial weight to the modified crutch, the modification will not interfere with a user while walking or standing, whether the leg is resting on the leg support means or not. Even though the bar 12 is fixed, the fact that the cushion 14 is freely-revolving provides unlimited pivoting motion to accommodate and allow resting of the leg regardless of the angle at which the crutch 10 makes contact with the ground. Therefore, the cushion 14 can conform immediately to any angle in which the shin, calf or cast makes contact while the leg rests and the body is thus relieved from supporting the injured and dangling leg. The enhanced comfort for the user also prevents the body and muscles from fatiguing or cramping.

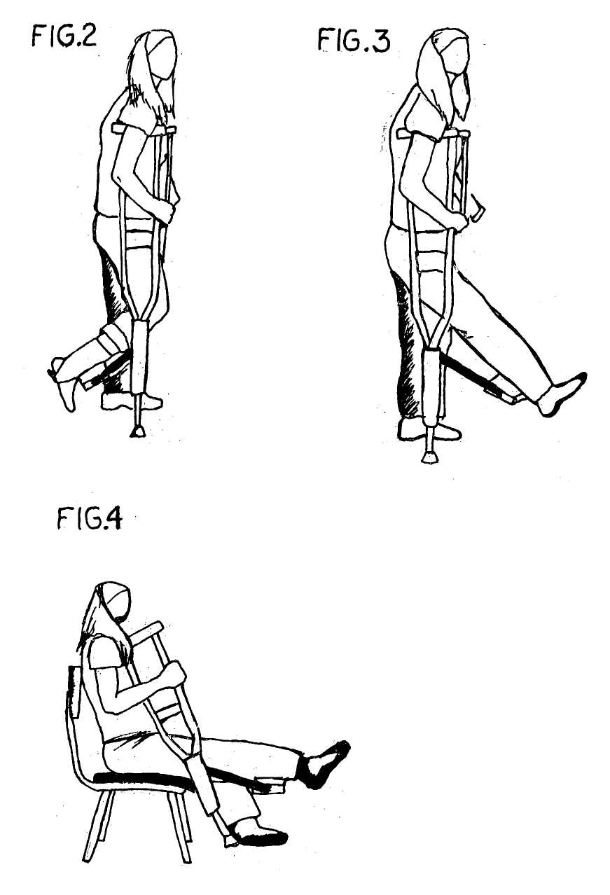

One mode of use of the current invention will now be described with reference to FIG. 2. With the bar 12 pointed forward, the user has elected to rest the calf or cast while standing with the knee flexed. Note how the weight of the injured leg or leg with the injured foot has been fully transmitted from the body's lower back, hip and/or shoulder (as in the situation with a standard crutch) to the cushion 14 and bar 12, and thereby increasing user comfort, decreasing user pain and facilitating the healing process.

Another mode of use of the current invention will now be described with reference to FIG. 3. With the bar 12 and cushion 14 pointing backward, the user has elected to rest the shin or cast while standing with the knee partially bent. Note how the weight of the injured leg or leg with the injured foot has been fully transmitted from the body's lower back, hip and/or shoulder (as in the situation with a standard crutch) to the cushion 14 and bar 12, and thereby increasing user comfort, decreasing user pain and facilitating the healing process.

Yet another mode of use of the current invention will now be described with reference to FIG. 4. With the bar pointed forward, the user has elected to rest the calf or cast on the leg support (and not making contact with the floor or ground) while sitting with the knee flexed. Note how the weight of the injured leg or leg with the injured foot has been transmitted from the body's lower back, hip and/or shoulder to the cushion 14 and bar 12, and thereby increasing user comfort, decreasing user pain and facilitating the healing process. Also, resting the calf or cast on the cushion 14 while sitting preempts the foot awkwardly and uncomfortably resting on the ground or floor, which could otherwise create painful pressure points.

From the disclosure and descriptions of the invention shown or described herein, it can be appreciated that a crutch modified to allow resting of an injured foot or leg (and thus eliminating the need for the lower back, hips or shoulders to constantly compensate for the full weight of the unsupported leg) while the user is standing or sitting is possible, desirable and therapeutic by a simple modification of a crutch. Although the present invention has been disclosed in connection with specific embodiments, it will be apparent to those skilled in the art that variations from the illustrated embodiments may be undertaken without departing from the spirit and scope of the invention. It is intended that the following claims cover all equivalent modifications and variations as fall within the scope of the invention.

I claim:

1. A crutch assembly comprising:
a crutch frame;
a leg support frame member attached to said crutch frame; and
a rotatable leg support attached to said leg support frame member.

2. The crutch assembly of claim 1 wherein said leg support frame member is detachably attached to said crutch frame.

3. The crutch assembly of claim 2 wherein said leg support frame member and said crutch frame are configured for mutual, reversible attachment in a plurality of relative configurations, whereby said rotatable leg support is positionable in a plurality of positions relative to said leg support frame member.

4. The crutch assembly of claim 3 wherein said rotatable leg support is rotatably carried on a axle member, which axle member is attached to said leg support frame member.

5. The crutch assembly of claim 4 wherein said leg support member and said axle member are configured substantially from a bicycle pedal assembly.

6. The crutch assembly of claim 3 further comprising a padding member attached to said leg support member.

7. The crutch assembly of claim 5 further comprising a padding member attached to said leg support member.
